(19) United States
(12) Patent Application Publication
(10) Pub. No.: US 2009/0196029 A1
(43) Pub. Date: Aug. 6, 2009

(54) DISCHARGE LAMP AND FIXTURE THEREFOR

(76) Inventors: Richard Kurtz, Plainsboro, NJ (US); Edward Ma, Great Neck, NY (US)

Correspondence Address: THE LAW OFFICES OF THOMAS L. ADAMS, 120 EAGLE ROCK AVENUE, Suite 130, EAST HANOVER, NJ, 07936, US

(21) Appl. No.: 12/025,806

(22) Filed: Feb. 5, 2008

(51) Int. Cl. F21S 15/00; H01J 61/04; H01R 4/48

(52) U.S. Cl. 362/221; 313/631; 439/851

(57) ABSTRACT

A lighting assembly includes a discharge lamp having a discharge tube with a longitudinal centerline reaching between opposite ends of the tube. A pair of electrodes are mounted at opposite ends of the discharge tube. The lamp has a pair of connectors each connected to a different corresponding one of the pair of electrodes. Each of the connectors have at least one pin (a) externally mounted alongside the discharge tube without extending past the ends of the tube, and (b) extending at an angle no greater than an acute angle relative to the centerline. The assembly also has a lamp fixture with an elongate housing and a pair of sockets mounted at opposite ends of the housing. Each of the sockets includes at least one longitudinal slot having an opening extending longitudinally between a proximal side of the slot and an open distal side of the slot. The longitudinal slot has an electrical contact. The at least one pin of the pair of connectors is snapped into the longitudinal slot against the electrical contact of the pair of sockets.

### BACKGROUND OF THE INVENTION

1. Field of the Invention

The present invention relates to discharge lamps and fixtures therefor, and in particular, to lamps and fixtures that allow the lamps to illuminate across the entire fixture as well as pin connections to facilitate such entire illumination.

2. Description of Related Art

Discharge lamps operate by placing a relatively high potential between electrodes at opposite ends of a discharge tube filled with an inert gas that is stimulated by a discharge current through the tube. The discharge tube is typically coated internally with a phosphorescent material to convert ultraviolet light generated by the discharge into visible light. In conventional fluorescent lamps the electrodes may be filaments that are initially heated by an electrical current to thermally emit electrons and start the discharge current through the tube.

Since the discharge tubes are initially open at either end, lamp fabrication typically proceeds by inserting electrodes in the open ends. These electrodes may be mounted on leads embedded in a glass stem. This glass stem can be fused to the discharge tube. An evacuation tube integral with the glass stem can be used to evacuate the discharge tube before filling it with an inert gas and then sealing it.

Conventional fluorescent lamps have on each end of the discharge tube a pair of electrical pins that extend past the end of the tube parallel to the length of the tube. These pins are designed to fit into sockets located at either end of the discharge tube. When such a lamp and sockets are assembled, the lamp shines only along the active length of the discharge tube. Obviously, no light is emitted along the interval where the sockets are placed. The dark region is actually greater than the space occupied by the sockets since conventional fluorescent lamps are typically fitted at each end with a metal cap that blocks light.

If such assemblies are placed end to end there is a noticeable gap in the illumination in the vicinity of the sockets. These gaps cause uneven light distribution and can be visually objectionable when the lamps themselves are directly visible.

See also U.S. Pat. Nos. 2,029,628; 2,056,635; 2,160,786; 4,092,562; 4,278,911; 4,713,500; 4,863,394; 5,588,884; 5,906,427; 5,931,691; 5,969,938; 5,971,814; 6,139,347; 6,252,188; 6,749,470; 6,837,755; 7,063,555; 7,114,247; and D396,122; D424,230; and D521,173.

### SUMMARY OF THE INVENTION

In accordance with the illustrative embodiments demonstrating features and advantages of the present invention, there is provided a discharge lamp including a discharge tube and a pair of electrodes mounted at opposite ends of the discharge tube. The discharge tube has a longitudinal centerline reaching between opposite ends of the tube. also included is a pair of connectors each connected to a different corresponding one of the pair of electrodes. Each of the connectors have at least one pin (a) externally mounted alongside the discharge tube without extending past the ends of the tube, and (b) extending at an angle no greater than an acute angle relative to the centerline.

In accordance with another aspect of the invention there is provided a fixture for a discharge lamp. The fixture includes an elongate housing and a pair of sockets mounted at opposite ends of the housing. Each of the sockets includes at least one longitudinal slot having an opening extending longitudinally between a proximal side of the slot and an open distal side of the slot. The longitudinal slot has an electrical contact.

In accordance with yet another aspect of the invention, there is provided a lighting assembly that includes a discharge tube and a pair of electrodes mounted at opposite ends of the discharge tube. The discharge tube has a longitudinal centerline reaching between opposite ends of the tube. Also included is a pair of connectors each connected to a different corresponding one of the pair of electrodes. Each of the connectors has at least one pin (a) externally mounted alongside the discharge tube without extending past the ends of the tube, and (b) extending at an angle no greater than an acute angle relative to the centerline. the assembly also has an elongate housing and a pair of sockets mounted at opposite ends of the housing. Each of the sockets includes at least one longitudinal slot having an opening extending longitudinally between a proximal side of the slot and an open distal side of the slot. The longitudinal slot has an electrical contact. The at least one pin of the pair of connectors is snapped into the longitudinal slot against the electrical contact of the pair of sockets.

By employing apparatus of the foregoing type, an improved discharge lamp and lamp fixture is achieved. In a disclosed embodiment, a discharge tube illuminates along its entire length including its end walls. Dark regions are avoided by mounting connectors on the side of the discharge lamp near its ends but without extending beyond the ends. In one embodiment cylindrical stubs extend radially from the side of a discharge tube and are sealed to glass stems that support an electrode that extends into the main cavity of the discharge tube. Consequently, this discharge lamp illuminates along its entire length and its connectors do not extend past the lamp bands to create a dark region.

In one embodiment, the lamp connectors include at each end a pair of inwardly directed electrical pins that are parallel to the centerline of the lamp. Using a pair of pins allows electrical heating of a filament inside the lamp's discharge tube, as is typical in a fluorescent lamp.

In this embodiment the lamp may be mounted in a fixture having mating sockets at either end. The socket can have a pair of slots with metal contacts for engaging the pins of the lamp connector. The slots may be adjacent to a receptacle for receiving a frame that cradles the lamp's discharge tube and supports the pair of electrical pins. The socket can also have male or female power connection devices for receiving incoming power and daisy chaining to other lamp fixtures.

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is an exploded perspective view of a lighting assembly including a discharge lamp and a fixture therefor, all in accordance with principles of the present invention;

FIG. 2 is a detailed, perspective view of a fragment of the lamp of FIG. 1;

FIG. 3 is cross-sectional view of the lamp fragment of FIG. 2 taken along line 3-3 (intersecting the centerline 14A of tube 14);

FIG. 4 is a side view of one end of the apparatus of FIG. 1, assembled;

FIG. 5 is an exploded, perspective view of the socket of FIG. 4;

FIG. 6 is a front view of the contact holder of FIG. 5;

FIG. 7 is a cross-sectional view of the contact holder taken along line 7-7 of FIG. 5;

FIG. 8 is an end view of the fixture of FIG. 1; and

FIG. 9 is a cross-sectional view of the elongated housing of the fixture of FIG. 1.

### DETAILED DESCRIPTION OF THE PREFERRED EMBODIMENTS

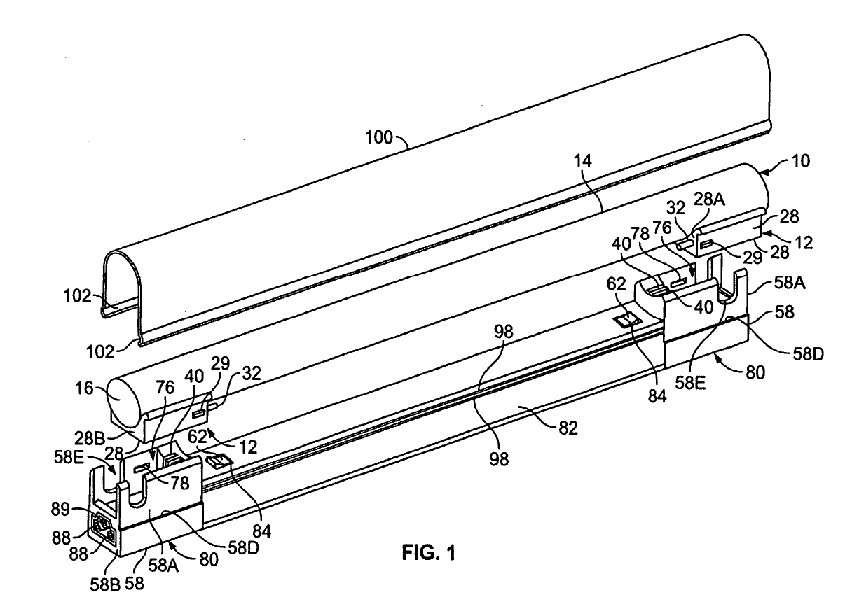

Referring to FIGS. 1-3, a lamp 10 has a pair of connectors 12 mounted at opposite ends of discharge tube 14. In this embodiment tube 14 is essentially a glass cylinder that is closed at each end by a flat, glass, circular wall 16. Discharge tube 14 has a longitudinal centerline, in this case the cylindrical axis 14A (although the centerline need not be straight if, for example, the discharge tube folds back or follows a serpentine other type of path). The inside of wall 16 and the inside of discharge tube 14 has a phosphorescent coating 15 as is typically found in discharge tubes (e.g., fluorescent lights, neon lights, etc.).

Tube 14 has a pair of transverse tubular stubs 18 located inwardly from each of the two walls 16. Stubs 18 are first installed as open cylindrical glass sleeves fused to a mating opening in the circumference of tube 14. The distal ends of stubs 18 are then fused to glass stem 20. Stem 20 is fabricated with a pair of electrical leads 24 embedded therein. Electrical leads 24 each emerge from opposite ends of stem 20. The inside ends of leads 24 are bent and crimped onto opposite ends of electrode 26, shown herein as a spiral filament. Electrode 26 may be spaced inwardly from wall 16 (FIG. 3) approximately ¾ inch (2 cm) although this spacing may vary in other embodiments, especially for different sizes of lamps.

Before installation, stem 20 may have an integral evacuation tube (not shown) communicating with tunnel 22 originally running the length of stem 20. When stem 20 is first installed on stub 18 the evacuation tube will communicate through tunnel 22 to the interior of discharge tube 14. In a conventional manner, the evacuation tube can be used to evacuate discharge tube 14 and refill it with an inert gas. The evacuation tube is then sealed (tipped-off) to seal tube 14, and doing so will partially collapse tunnel 22. Discharge tube 14 is in this embodiment ½ inch (1.3 cm) in diameter (T8 size) although other sizes are contemplated (T2, T5, T12, etc.). In this embodiment tube 14 is 19 inches (48 cm) long although other lengths are contemplated and the axis of the tube 14 need not be straight in all embodiments. In fact, tube 14 will not be cylindrical in some embodiments. Also, stub 18 is about ⅜ inch (1 cm) in diameter, although again, this dimension will vary depending upon lamp size and other physical considerations.

Transverse stub 18, when finished, fits inside cradle 28, shown as a five sided box with a proximal face 28A, distal face 28B, two sidewalls 28, and a floor 28D. Sidewalls 28C are capped with a bead 30 and have a detaining nub 29 in the shape of a triangular prism (for purposes to be described presently). Walls 28A and 28B have a arced border designed to engage and cradle the circumference of discharge tube 14. Cradle 28 is plastic and about ½ inch (1.3 cm) long although different sized cradles may be used depending upon the lamp size and other physical considerations.

A cantilevered pair of tubular pins 32 are mounted in openings in proximal wall 28A with flanges 32A abutting wall 28A. In particular, the tubular inside end of pins 32 are swaged in place. The external ends of leads 24 are separately threaded through tubular pins 32 before crimping pin 32 as indicated by crimping dimples 34. Any excess length of lead 24 protruding past the end of pin 32 can be snipped off. In this embodiment exposed length of pins 32 are approximately ½ inch (1.3 cm) and spaced about ½ inch (1.3 cm) apart, although different lengths and spacings may be employed in other embodiments.

Pins 32 on each of the connectors 12 point inwardly toward each other end, extend in the same direction as centerline 14A, and are in fact parallel (although being parallel is not necessary because some non-parallel pins will still be deemed to point toward each other or extend in the same direction as a centerline, which centerline need not be straight). The interior of cradle 28 is filled with a potting compound that holds together and reinforces this assembly.

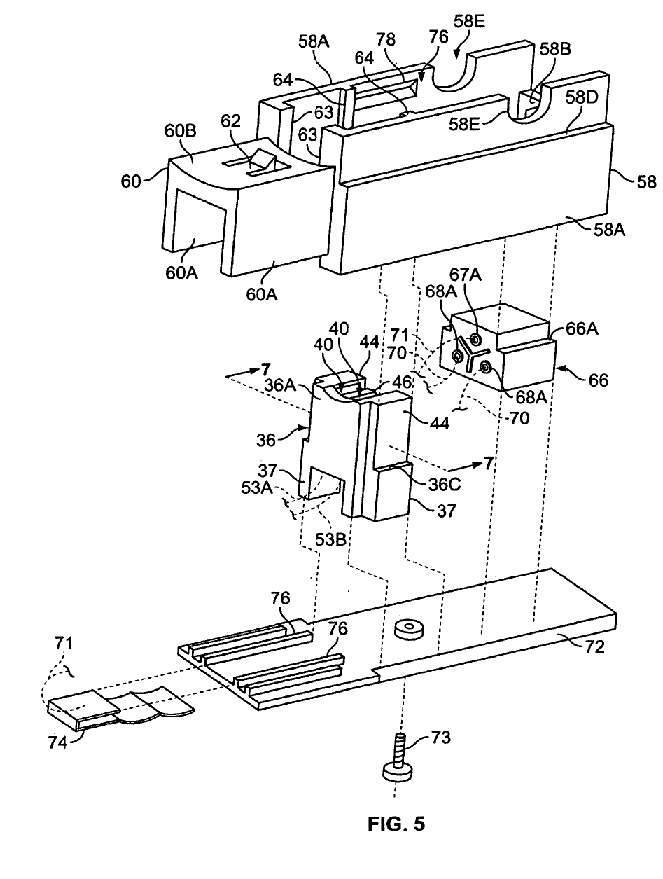

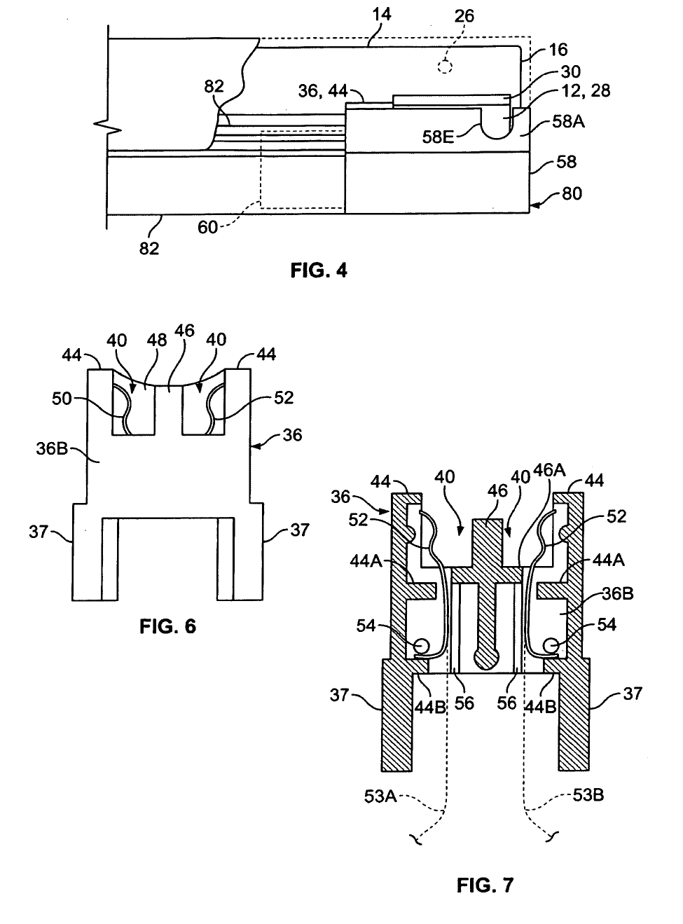

Referring to FIGS. 4-7, plastic contact holder 36 is part of previously mentioned connector 12. Holder 36 has a pair of legs 37 forming an arch. Holder 36 also has a central ridge 46 forming between side ridges 44 a pair of valleys 40, herein referred to as longitudinal slots or longitudinal openings. Wall 36A on the proximal side of holder 36 substantially closes one end of slots 40. Wall 36B on the distal side of holder 36 is shorter and leaves slots 40 at least partially open on that end.

Central ridge 46 has an opposing pair of shelves 46A partially forming a floor for slots 40. The insides of ridges 44 each have an inwardly directed shelf 44A located slightly below shelves 46A as well as an inwardly directed shelf 44B located below shelf 44A. A pair of internal pins 54 project perpendicularly from wall 36B just over shelves 44B.

A pair of lamp contacts 52 are shown as metal strips each with a right angle bend that fits between shelf 44B and pin 54. Electrical leads 53A and 53B (shown in phantom) are soldered to contacts 52 near these bends. Each of the electrical contacts 52 extend from shelf 44B, between shelves 44A and 46A, and into slots 40. An edge of the contacts 52 fit into the corners formed between wall 36B and the parallel ridges 56 formed on the inside of wall 36B. The ends of contacts 52 in slots 40 have a zigzag bend for presenting a convex/concave surface to the slot. The inside faces of ridges 44 are relieved to provide clearance allowing the contacts 52 to flex away from each other.

FIG. 5 shows a plastic frame 58 with two parallel side walls 58A spanned on one end by annular wall 58B and on the other end by a coupling 60 having two side walls 60A spanned by a trough-like upper wall 60B. Wall 60B has a C-shaped cutout creating a cantilevered finger 62 with a flared tip forming a ramp. Coupling 60 provides an arched wireway communicating with the space between walls 58A. Walls 58A each have a shoulder 58D and finger access notches 58E.

The insides of walls 58A each have a parallel pair of guide ridges 63 and 64 (walls 58A are mirror images of each other). Contact holder 36 can slide between guide ridges 63 and 64. The insides of walls 58A also have an opposite pair of rectangular recesses (not shown) for slidably receiving power connection device 66.

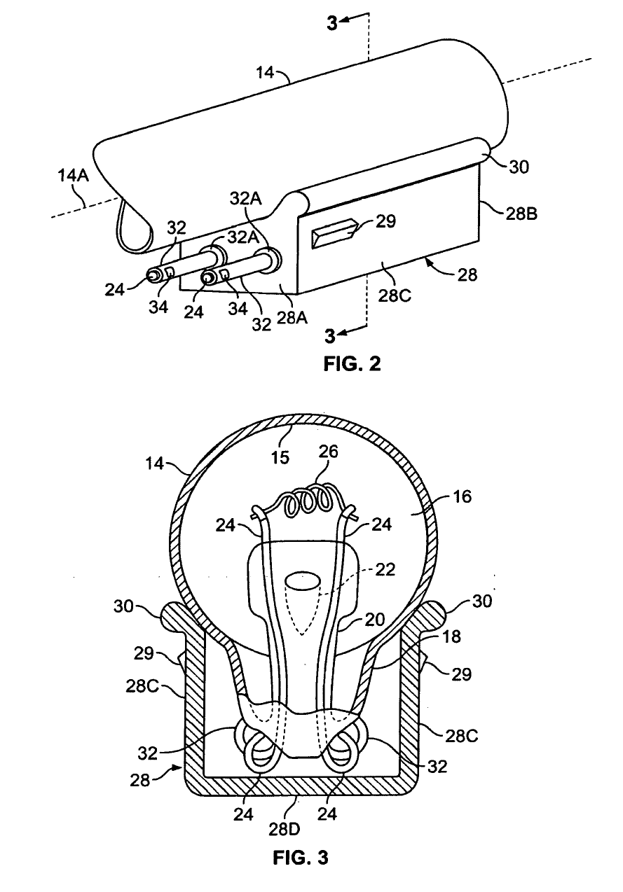

Power connection device 66 of FIG. 5 is an optional, plastic, injection molded block within an outwardly facing cavity containing either a male connector (a trio of metal pins similar to the pins 32 FIG. 2) or a female connector (described in further detail hereinafter as an integral embossment with a trio of cylindrical throughbores fitted with metal contact sleeves). In either event, the proximal, metallic, tubular ends 67A and 68A of this female (or male) contact element is shown in FIG. 5 intruding through the proximal face of connection device 66. Metallic tubular ends 67A and 68A are swaged in place together with terminal lugs (not shown but indicated schematically as part of the phantom electrical leads 70 and 71).

Elements 36 and 66 are captured by cover plate 72 and therefore cannot slide downwardly out of frame 58. Plate 72 is held in place by screw 73, which is threaded into a stud (not shown) depending from a wall (also not shown) bridging walls 58A. Elements 36 and 66 cannot slide upwardly out of frame 58 because their respective shoulders 36C and 66A engage overhanging stops (not shown) on the inside of walls 58A.

A grounding clip 74 is shown as a metal strip having one end folded to form a hook that slips over the edge of cover plate 72 between ridges 76. The longer leg of clip 74 is bowed and lies along the outside of cover plate 72 in order to make electrical contact with a housing to be described presently. Grounding clip 74 is electrically connected to tubular ends 67A of the ground contacts of block 66 as indicated by previously mentioned phantom lead 71, which may be soldered to clip 74.

When slid into place, contact holder 36 extends from cover plate 72 between ridges 63 and 64 to just past the opposite edge of walls 58A. As a result, distal face 36B of holder 36 bounds one side of a receptacle 76 that is also bounded on two other sides by walls 58A. The fourth side of receptacle 76 is bounded by the edge of annular wall 58B. Receptacle 76 is designed to receive the previously mentioned cradle (cradle 28 of FIG. 2). Nub 29 of cradle 28 can snap into the detent recess 78 (FIG. 5) formed on the inside of complementary walls 58A.

Referring to FIGS. 1, 4, 5 and 8, a pair of the previously mentioned frames (frame 58 of FIG. 5) are each shown assembled to form a socket 80 with its coupling 60 inserted into either end of hollow elongate housing 82. Previously mentioned cantilevered fingers 62 are shown snapped into holes 84 in the top of housing 80. Previously mentioned leads 53A and 53B are routed through coupling 60 into housing 82. Likewise, previously mentioned leads 70 are routed under holder 36 between legs 37 into housing 82.

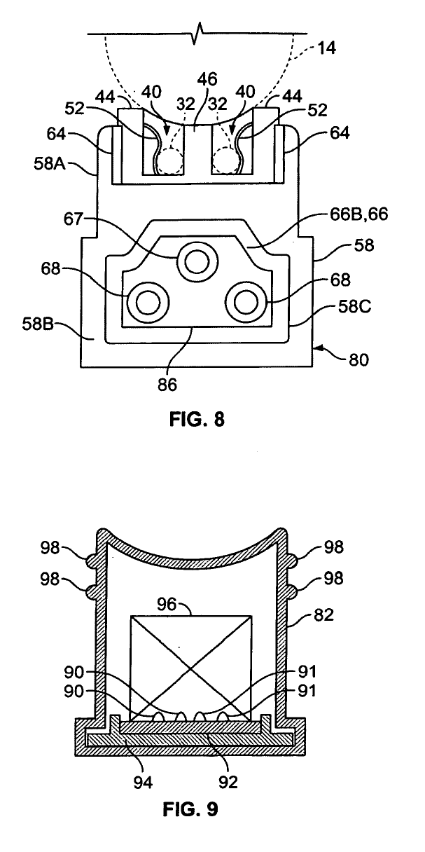

In FIG. 8 cavity 66B of previously mentioned power connection device 66 is partially visible through the opening 58C in annular wall 58B of frame 58. Outwardly projecting from the back of cavity 66B is an embossment 86 with a trio of cylindrical throughbores fitted with metal contact sleeves 67 and 68. The inside ends of sleeves 67 and 68 form the tubular ends previously illustrated in FIG. 5 as ends 67A and 68A, respectively.

This configuration constitutes a female power connection device located at one end of housing 82. The opposite end of housing 82 is fitted with a male power connection device whose trio of pins 88 and 89 are visible in FIG. 1 through the opening in annular wall 58B of frame 58. It will be appreciated that the two frames 58 are identical but can receive either kind of power connection device, that is, either a male or female power connection device.

Power is supplied to the unit of FIG. 1 through pins 88 and 89, which are commonly connected to previously mentioned contact sleeves 67 and 68, respectively, of FIG. 8. Accordingly, input power can be conveyed through the device of FIG. 1 so that similar units can be daisy chained together. The unit to unit connection can be made by a short adapter (not shown) designed to allow the units to abut end to end, although in some embodiments a longer cable (not shown) can be used where a greater unit to unit spacing is desired.

Referring to FIG. 9, housing 82 is in this embodiment an aluminum extrusion containing a printed circuit board 92 resting on insulating base 94. Power for operating board 92 is applied to terminal pair 90 by the common connection to the power leads associated with the male and female connection devices (e.g., leads 70 of FIG. 5). Board 92 also has two pairs of output terminals (terminal pair 91 being visible in FIG. 9) for connecting to the lamp contacts (for connecting to lamp contacts 52 through, for example, leads 53A and 53B of FIG. 7).

The power received on terminals 90 is applied to electrical circuit 96 mounted on circuit board 92. In this embodiment circuit 96 is a conventional instant start, no flickering, silent electronic ballast. Circuit 96 initially provides on output terminals 91 a current for incandescently heating the lamp filament (filament 26 of FIG. 3) at one end of the lamp. Complementary terminals (not shown) on board 92 will incandescently heat the filament at the other end of the lamp. It will be appreciated that these four terminals 90 and 91 are electrically distinct. It will also be appreciated that circuit 96 is optional and in some cases circuitry (either conventional or electronic) may be mounted outside of the lamp fixture.

Once the incandescently heated filaments begin thermally emitting electrons, circuit 96 will then apply a discharge voltage between the two filaments to support a discharge current through tube 14 in the usual manner. This discharge voltage may be conventional house current at 120 V, 60 Hz (or other voltages depending upon local standards; or a much higher voltage in the case of neon lights, cold cathode lamps, etc.).

Referring to FIG. 1, an optional lamp cover 100 is shown as a clear plastic extrusion having an inverted U-shaped cross-section terminating in beads 102 that are designed to snap between ridges 98 on the outside of housing 82. Beads 102 can also rest against shoulders 58D of frames 58.

To facilitate an understanding of the principles associated with the foregoing apparatus, its operation will be briefly described. When installing or replacing the lamp, lamp 10 of FIG. 1 is positioned so that each of the cradles 28 of connectors 12 align with receptacle 76 while pins 32 align with slots 40. Lamp 10 is then pressed downwardly to drive pins 32 against contacts 52 (FIG. 7). Contacts 52 are driven outwardly and can flex into the relieved regions on the inside of ridges 44. Eventually pins 32 arrive at the position shown in phantom in FIG. 8 where pins 32 snap into the concave sections of contacts 52. At the same time nubs 29 of cradle 28 snap into the detaining cavity 78 (FIG. 5) to hold lamp 10 firmly in place. Thereafter, lamp cover 100 can be snapped on to housing 82 as previously described in order to cover lamp 10 along its entire length.

Accordingly, contacts 52 (FIG. 7) are connected through leads 53A and 53B to corresponding terminals 91 (FIG. 9) on printed circuit board 92. The power supplied to terminals 90 in the manner previously described, enables the appropriate drive to terminals 91 during startup and later during normal operation.

In a known manner, the discharge current from filament electrodes 26 (FIG. 4) stimulate the gas inside discharge tube 14 to produce a UV emission. This emission stimulates the phosphorescent coating 15 on the inside of tube 14 along its entire length between end walls 16 to produce visible light. In fact the UV emission will stimulate the coating on the inside of end walls 16 so they will produce visible light as well.

Consequently, this lighting assembly will provide illumination along its entire length. In instances where the units are connected and abutted end to end, the illumination will extend from unit to unit effectively without a dark gap.

It is appreciated that various modifications may be implemented with respect to the above described embodiments. While parts of the previously mentioned connector and socket are described as injection molded plastic, other embodiments may use ceramic, phenolic or other insulating materials. Also, while the previously mentioned cradle and receptacle are rectangular, in other embodiments these components may be cylindrical, a triangular prism, or have other shapes. In addition, these components may be made from a number of pieces that attach together by snap fittings, glue, pin and socket joints, or other means. The previously illustrated electrical pins may in some embodiments be curved, tapered, flared, have enlarged ends, or have other shapes. Also, these pins may be parallel to the length of the discharge tube or skewed at an angle that is less than acute, that is, less than 90° (for example, 45°). While a parallel pair of inwardly pointing pins are shown, some embodiments may have a pair of pins on one end of the lamp that point in opposite directions (either lengthwise or transverse to the length of the discharge tube). Moreover, some embodiments may have pins that are located in cavities on cradles mounted the side of the discharge tube. Also, some lamps (e.g., neon lamps, cold cathode lamps, etc.) may only have a single pin on each end of the lamp. Moreover, the lamp socket may have contacts in the form of a pair of metal fingers that squeeze each pin from opposite sides. In addition, some embodiments may have lamp sockets with contacts that slide axially onto the electrical pins of the lamp. While the illustrated lamp fixture is shown as a single unit, in some embodiments separate sockets can be provided that are mounted onto a wall or other structure at a distance and with an alignment appropriate to receive and connect to the lamp.

Obviously, many modifications and variations of the present invention are possible in light of the above teachings. It is therefore to be understood that within the scope of the appended claims, the invention may be practiced otherwise than as specifically described.

1. A discharge lamp comprising:
a discharge tube having a longitudinal centerline reaching between opposite ends of said tube;
a pair of electrodes mounted at opposite ends of said discharge tube; and
a pair of connectors each connected to a different corresponding one of said pair of electrodes, each of said connectors having at least one pin (a) externally mounted alongside said discharge tube without extending past the ends of said tube, and (b) extending at an angle no greater than an acute angle relative to said centerline.

2. A discharge lamp according to claim 1 wherein the at least one pin in each of the pair of connectors extends in substantially the same direction as said centerline.

3. A discharge lamp according to claim 1 wherein the at least one pin of the pair of connectors are substantially parallel to one another.

4. A discharge lamp according to claim 1 wherein the at least one pin of the pair of connectors is cantilevered to point inwardly.

5. A discharge lamp according to claim 1 wherein the at least one pin of the pair of connectors is cantilevered to point toward one another.

6. A discharge lamp according to claim 1 wherein said tube has an opposite pair of transverse tubular stubs, said pair of electrodes being mounted at a different corresponding one of said stubs.

7. A discharge lamp according to claim 1 wherein each of said electrodes comprises:
a glass stem fused in a corresponding one of said transverse tubular stubs; and
at least one lead embedded in said glass stem and connected to the pin in a neighboring one of said connectors.

8. A discharge lamp according to claim 7 wherein said at least one lead embedded in said glass stem comprises a pair of leads, said electrode comprising a filament connected between said pair of leads, said at least one pin comprising a pair of pins separately connected to said pair of leads of an associated one of said electrodes, said discharge tube having an internal fluorescent coating.

9. A discharge lamp according to claim 1 wherein each of said electrodes comprise a filament, the at least one pin in each of said connectors comprising an adjacent pair of pins, the filament in each of said electrodes being connected across the adjacent pair of pins in a different associated one of said connectors.

10. A discharge lamp according to claim 1 wherein said discharge tube terminates at each end with a substantially flat circular wall.

11. A discharge lamp according to claim 10 wherein said internal pair of electrodes are spaced inwardly from the circular wall at each end of said discharge tube.

12. A discharge lamp according to claim 1 wherein said pair of connectors each comprise:
a cradle for holding said tube and supporting said at least one pin.

13. A discharge lamp according to claim 12 wherein said cradle has a proximal face supporting said at least one pin and a distal face.

14. A discharge lamp according to claim 13 wherein said tube has an opposite pair of transverse tubular stubs projecting into the cradle of the pair of connectors, each of said electrodes comprising:
a glass stem fused in a corresponding one of said transverse tubular stubs; and
at least one lead embedded in said glass stem and connected by crimping to the pin in a neighboring one of said connectors.

15. A fixture for a discharge lamp comprising:
an elongate housing; and
a pair of sockets mounted at opposite ends of said housing, each of said sockets including at least one longitudinal slot having an opening extending longitudinally between a proximal side of the slot and an open distal side of the slot, said longitudinal slot having an electrical contact.

16. A fixture according to claim 16 wherein said proximal side of said slot is closed.

17. A fixture according to claim 16 wherein each of said sockets has a receptacle located distally from said slot and having a depth at least as great as that of said slot.

18. A fixture according to claim 16 wherein said at least one longitudinal slot with an electrical contact includes a pair of longitudinal slots each having an electrical contact.

19. A fixture according to claim 20 comprising:
an electrical circuit mounted in said housing and having a plurality of electrically distinct terminals, the electrical contacts of the pair of longitudinal slots being connected to different ones of the electrically distinct terminals.

20. A fixture according to claim 20 comprising:
a light cover snapped onto said housing.

21. A fixture according to claim 16 wherein said housing is tubular, each of said pair of sockets each comprising:
a frame with a coupling sized for end insertion into said housing.

22. A fixture according to claim 23 wherein said housing has a pair of holes, said coupling having a cantilevered finger with a tip sized to snap into a corresponding one of said holes in said housing.

23. A fixture according to claim 23 wherein said pair of sockets each comprise:
a contact holder for holding said electrical contact and providing said longitudinal slot, said frame having an opening for slidably receiving said contact holder

24. A fixture according to claim 25 comprising:
a male and a female power connection device slidably mounted on a different corresponding one of said pair of sockets.

25. A lighting assembly comprising:
a discharge tube having a longitudinal centerline reaching between opposite ends of said tube;
a pair of electrodes mounted at opposite ends of said discharge tube;
a pair of connectors each connected to a different corresponding one of said pair of electrodes, each of said connectors having at least one pin (a) externally mounted alongside said discharge tube without extending past the ends of said tube, and (b) extending at an angle no greater than an acute angle relative to said centerline;
an elongate housing; and
a pair of sockets mounted at opposite ends of said housing, each of said sockets including at least one longitudinal slot having an opening extending longitudinally between a proximal side of the slot and an open distal side of the slot, said longitudinal slot having an electrical contact, said at least one pin of said pair of connectors being snapped into the longitudinal slot against said electrical contact of said pair of sockets.
